(19) United States
(12) Patent Application Publication
(10) Pub. No.: US 2003/0087665 A1
(43) Pub. Date: May 8, 2003

(54) REMINDER FUNCTION FOR MOBILE COMMUNICATION DEVICE

(76) Inventor: TIMO TAPANI TOKKONEN, OULU (FI)

Correspondence Address: SCHEEF & STONE, L.L.P., 5956 SHERRY LANE, SUITE 1400, DALLAS, TX, 75225, US

(21) Appl. No.: 09/459,452

(22) Filed: Dec. 13, 1999

(51) Int. Cl. H04M 11/10; H04M 1/00; H04B 1/38

(52) U.S. Cl. 455/556

(57) ABSTRACT

A mobile communication device having a reminder function that may be associated functionally with triggering events and triggered actions associated with the mobile communication device. The invention allows a user of a mobile communication device to configure a desired reminder and associate the configured reminder with a triggering event. Upon the occurrence of the triggering event, a defined action associated with the reminder occurs. The invention allows the user of a mobile communication device to connect a reminder, triggering event and a defined action together to realize an efficient reminder function that is based on an event or events when the occurrence of the event or events may happen arbitrarily.

### FIELD OF THE INVENTION

This invention relates to mobile communication devices and, more particularly, to a communication device having a reminder function, wherein the reminder function may be associated with external triggering events and triggered actions of the communication device.

### BACKGROUND

As advances in technology allow portable communication devices to decrease in size while at the same time to become more sophisticated in function, communication devices are becoming more and more an integral part of daily life.

A large variety of portable communication devices currently exists, each having a different degree of sophistication as far as the features offered. Mobile telephones are the most common and continue to grow in sophistication. Another common device is a Personal Digital Assistant (PDA). PDAs allow users to store and manipulate data and information useful in their work and daily lives. PDAs may be configured to download and store programs and information from a computer. Some PDAs offer reminder or scheduling functions that allow a user to input information or appointments and set a reminder function for a specific time that is triggered by a timer within the device to remind the user of an appointment or to do a task connected with the input information. The reminder function may trigger an alarm or display function to remind the user of something that has to be done. PDAs have been developed that have the capability to send and receive email through wireless interfaces. PDAs have also been developed that include mobile telephone functionality.

Communicator-type devices that combine mobile telephone functions and PDA-type features in one portable unit have also been developed. As these communicator-type devices grow in sophistication and decrease in size, the functions and features offered will increase in number.

The examples given above of the mobile telephone, communicator and the PDA are only three of many portable communication devices currently available or under development. Technology is moving in the direction of integration of all the functions of the different types of portable devices available today into one universal device. As this integration happens, it would be useful to provide enhanced functions that take advantage of the various features that are combined together in portable communication devices as these portable communication devices evolve.

### SUMMARY OF THE INVENTION

The present invention provides a mobile communication device having a reminder function that may be associated functionally with triggering events and triggered actions associated with the mobile communication device. The invention allows a user of a mobile communication device to configure a desired reminder and associate the configured reminder with a triggering event initiated externally to the communication device. Upon the occurrence of the triggering event, a defined action associated with the reminder occurs. The invention allows the user of a mobile communication device to connect a reminder, triggering event and a defined action together to realize an efficient reminder function that is based on an event or events when the occurrence of the event or events may happen arbitrarily.

In an embodiment of the invention, the reminder function of the invention is implemented in a mobile telephone. The mobile telephone has a reminder storage function, wherein each reminder stored may be associated with an external triggering event. The association between the stored reminder and triggering event may be stored in memory. An action may also be defined as associated with the reminder and triggering event, and the association between the defined action and reminder and triggering event may be stored in memory. Upon the occurrence of the triggering event, the defined action associated with the reminder that is associated with the triggering event is initiated. The reminder may comprise stored text, picture, audio, or another form of stored information. The triggering event may be a phone call outgoing from the mobile phone, or a received phone call. The defined action may be an action to be performed, such as displaying or playing of the reminder at the mobile station, transmitting a short message service (SMS) message including the reminder, or other form of communication for conveying the reminder. The defined action is performed upon detection of the triggering event in the mobile telephone.

### BRIEF DESCRIPTION OF THE DRAWINGS

FIG. 1 is a block diagram of a mobile phone into which an embodiment of the invention is implemented;

FIG. 2 is a flow diagram showing process steps performed in the mobile phone of FIG. 1, according to an embodiment of the invention; and

FIG. 3 is an illustration of a mobile telephone display showing user prompts according to an embodiment of the invention.

### DETAILED DESCRIPTION OF THE INVENTION

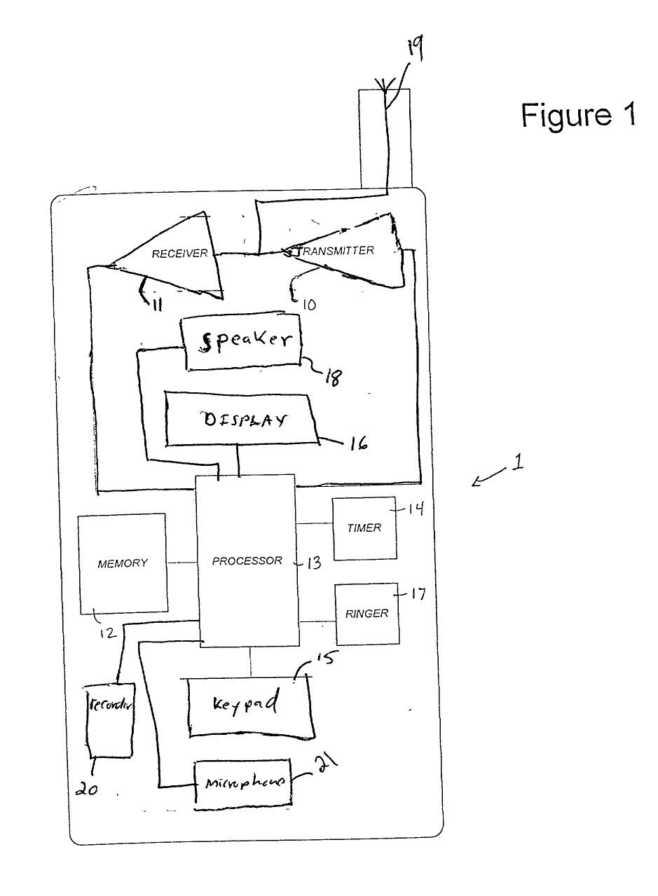

Referring now to FIG. 1, therein is illustrated a block diagram of a mobile phone into which an embodiment of the invention is implemented. Mobile telephone 1 comprises transmitter 10, receiver 11, antenna 19, memory 12, processor 13, ringer 17, keypad 15, recorder 20, speaker 18, microphone 21 and display 16. Mobile telephone 1 operates as a mobile telephone having additional functions including a reminder function according to an embodiment of the invention. Memory 12 represents a collective memory for mobile telephone 1 and may include RAM, ROM, Subscriber Identity Module (SIM) memory, and memory internal to processor 13. Memory 12 includes a code that controls the operation of processor 13 to implement functions according to the embodiment of the invention. Processor 13 generates appropriate commands and controls the other component blocks of mobile telephone 1 to provide conventional functions of a mobile telephone and also allow operation according to the embodiment of the invention.

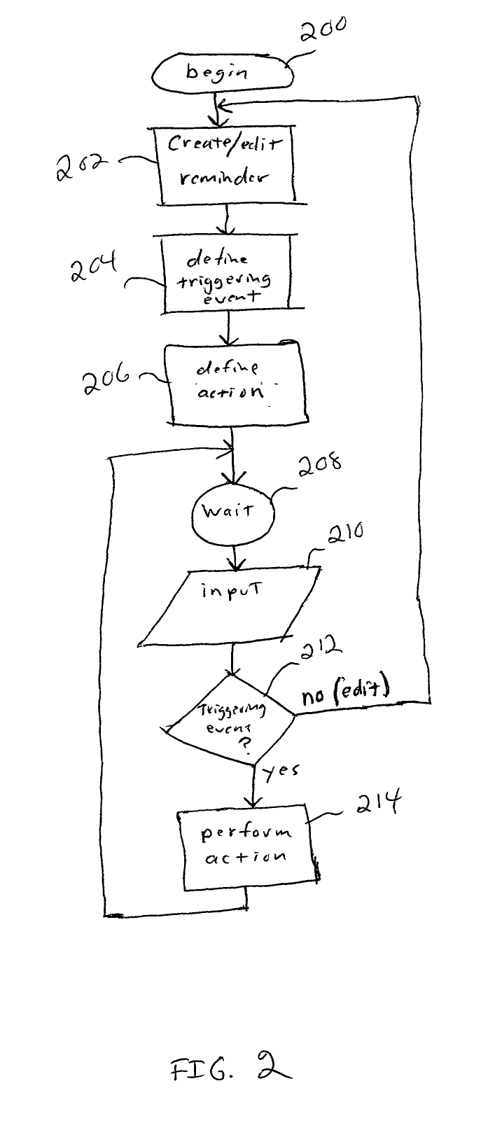

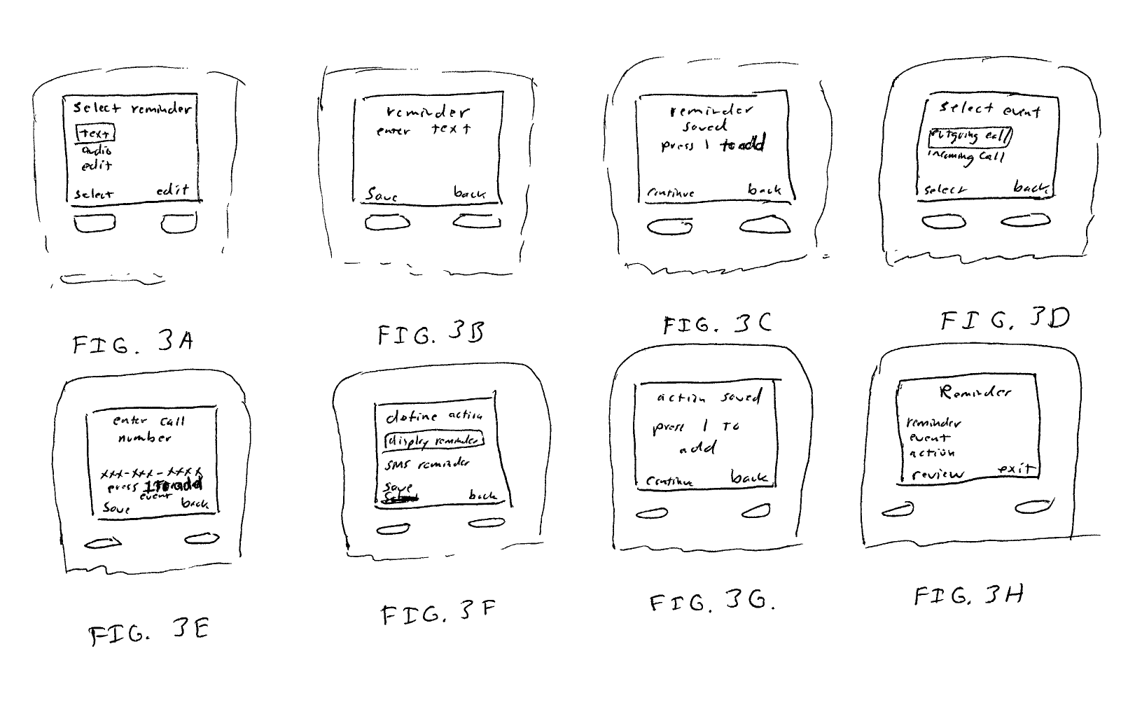

Referring now to FIG. 2, therein is a flow diagram showing process steps performed within mobile telephone 1 of FIG. 1, according to an embodiment of the invention. In the embodiment of the invention, the steps of FIG. 2 are performed by processor 13 under control of programs stored in memory 12 and in response to user input from keypad 15 or speaker 18, and external events. FIGS. 3A-3G illustrate an example of a possible sequence of prompts at display 16 for implementing the text reminder function for the process of FIG. 2 through an exemplary sequence of steps.

The process of FIG. 2. allows a user of mobile telephone 1 to create a reminder, select a triggering event associated with the reminder, and select an action that is to be performed with or using the reminder upon occurrence and detection of the triggering event. The process of FIG. 2 may also be used to configure the reminder function to create any combination and number of associated multiple reminders, triggering events or actions according to the embodiment of the invention. Multiple reminders may be selected and linked to multiple triggering events and multiple actions. For example, a reminder text note may be created that is to be sent by SMS to each of a number of multiple receivers upon a phone call being made to or received from a particular destination. This may remind each of the receiving parties that a phone conference is being set up. Instead of creating and sending a reminder text, an audio reminder could be recorded and a phone call to each receiving party to play an audio reminder could also be performed as an action.

The process begins at step 200 when a user of mobile telephone 1 initiates the reminder function. In the embodiment, this may be done by selecting a menu function using display 16 and keypad 15. Next, at step 202, mobile telephone 1 prompts the user for input selecting and creating or editing the type of reminder the user desires. FIG. 3A illustrates display 16 at the beginning of step 202. A reminder that is initially created may be edited by selecting an edit function after choosing the type of reminder. In the embodiment of FIG. 2, the process may allow the user to choose to edit an existing reminder, or create a text reminder or record an audio reminder as shown in FIG. 3A. FIG. 3B and FIG. 3C illustrate the display prompts for creating a text reminder. The text reminder is entered through keypad 15 as the input device in response to the prompt of FIG. 3B and stored in memory 12 for displaying on display 16. Upon entering and saving the text reminder, the user is prompted to continue or add another reminder as shown in FIG. 3C. Multiple reminders may be entered and associated with one another in this manner. If selected, an audio reminder may similarly be entered through microphone 21 or the input device and stored in memory 12 for playback by digital recorder 20. When the user enters continue in response to the prompt at FIG. 3C, the process moves to step 204. At step 204, the user is prompted by mobile telephone 1 to enter a triggering event. The triggering event definition may be entered in the same manner as the reminder is entered. FIGS. 3D and 3E illustrate prompts for selecting and defining a triggering event. In response to the prompt of FIG. 3D, the user may select a triggering event. The triggering event may be any event related to a function of mobile telephone 1, such as receiving a phone call or initiating an outgoing call from mobile telephone 1. Depending on the selected triggering event, processor 13 will create subsequent prompts at display 16 to ask for further input. For example, as illustrated in FIG. 3E, if an outgoing phone call is selected as the triggering event, processor 13 will initiate a further prompt to ask for a particular number or numbers, so that an outgoing phone call to the selected number(s) becomes the triggering event. The prompt shown in FIG. 3E also gives the user the option of pressing 1 after entering the number to add another triggering event, i.e., to associate more than one triggering event with the reminder(s) entered in step 202. A larger number of events then shown may be offered in the display prompt of FIG. 3D by allowing scrolling through a list of events. If the user presses save after entering a number in response to the prompt of FIG. 3E, the process moves to step 206. The triggering event(s) defined at step 204 is stored in memory 12 by processor 13 and is linked to the reminder that was created and stored at step 202. As an alternativee, a triggering event profile could also be entered, where the profile defines a hierarchy or sequence of triggering events that must happen in order to trigger an action.

In other alternative embodiments, devices for detecting triggering events external to mobile telephone 1 may be implemented into mobile telephone 1 to provide a signal to processor 13 upon occurrence of a selected external event. The external event may then be used as the triggering event. Such external triggering events may include location or movement in, or into, a selected area. The location or movement may be detected by a video device, GPS device, or by the presence of certain bluetooth devices or a thermometer that generates a signal to processor 13 or that is monitored by processor 13 to detect the triggering event.

Next, at step 206, the user is prompted to define an action. FIGS. 3F and 3G illustrate the prompt for defining an action. The action may be defined and entered into mobile telephone 1 in a similar manner as the reminder and triggering events are entered. The action may be entered in response to the prompt of FIG. 3F. The action may be an action, such as displaying a textual reminder entered in step 202, sending a short message service (SMS) message including a text reminder entered in step 202 to a selected number, playing an audio reminder recording entered in step 202, or making a phone call and playing an audio reminder entered in step 202. The action may include a combination of a number of more than one of these actions. For example, a combination of actions may include displaying a textual note and playing an audio recording or displaying a textual note and sending an SMS. A larger number of actions then shown may be offered in the display prompt of FIG. 3F by allowing scrolling through a list of actions. After entering the action, the user may be given a chance to add additional actions or continue as shown by the prompt of FIG. 3G. When the desired action or actions have been entered, the user is allowed to review the reminder, triggering event and action entries or exit, in response to the prompt of FIG. 3H. The defined action entered at step 206 is stored in memory 12 by processor 13 and is linked to the triggering event that was entered and stored at step 204.

Next, at step 208, the process moves to a wait state. While in the wait state of step 208, processor 13 waits for process input. In the embodiment, a process input may be a detection of a triggering event or a detection of an input indicating that the user desires to edit or change the reminder, triggering event or defined actions entered in steps 202-206. If it is determined at step 212 that the process input is not a triggering event, the process moves to step 202. At step 202, the user is prompted to begin editing the reminder by the prompt shown in FIG. 3A. In response to the edit input, the display may allow scrolling through a list of stored reminders to choose one to edit. The user may also redefine the triggering event and actions again at steps 204 and 206, respectively, as described previously. The wait state of step 208 will then be re-entered after the desired edits are made and edited.

If, however, at step 212, it is determined that the process input is a triggering event, the process moves to step 214. At step 214, the action is performed. The process then returns to the wait state of step 208.

While the embodiment of the invention has been described in connection with mobile telephones, embodiments of the invention have application to any type of mobile communication device. For example, text or audio reminders could be created in a PDA having wireless email receiving capabilities and a triggering event, such as sending or receiving an email to or from a particular email address, could trigger the performance of an action with the reminder. The action could be, for example, a text or audio reminder reminding the PDA user of something the user should tell the email receiver or sender the next time the user has an opportunity to do so. Also, the invention may be implemented with one or more of the reminders, triggering events or defined actions stored externally to the mobile within the system, or with different combinations of the functionality of the reminder(s), triggering events or defined actions performed elsewhere in the system than at the mobile station.

Thus, while the invention has been particularly shown and described with respect to preferred embodiments thereof, it will be understood by those skilled in the art that changes in form and details may be made therein without departing from the scope and spirit of the invention.

What is claimed is:

1. A method for generating a reminder in a communication device operating in a system, said method comprising the steps of:
generating a reminder from user input and storing said reminder in the system;
defining a triggering event and storing an indication of said triggering event in the system, wherein said triggering event is an event initiated external to the communication device;
defining an action and storing an indication of said action in the system;
detecting an occurrence of said triggering event; and
performing, in response to detecting said triggering event, said action at the communication device.

2. The method of claim 1, wherein said step of generating a reminder comprises generating a text reminder.

3. The method of claim 2, wherein said step of generating a text reminder comprises receiving keypad input at the communication device.

4. The method of claim 1, wherein said step of generating a reminder comprises generating an audio reminder.

5. The method of claim 4, wherein said step of generating an audio reminder comprises recording voice input at the communication device.

6. The method of claim 1, wherein said step of generating a reminder comprises generating a video reminder.

7. The method of claim 6, wherein said step of generating a video reminder comprises recording video input at the communication device.

8. The method of claim 1, wherein said step of defining a triggering event comprises the step of defining said triggering event as an incoming phone call from a selected phone number to the communication device.

9. The method of claim 1, wherein said step of defining a triggering event comprises the step of defining said triggering event as an outgoing phone call to a selected phone number from the communication device.

10. The method of claim 1, wherein said step of defining a triggering event comprises the step of defining said triggering event as an external event determinable by a sensor in the communication device.

11. The method of claim 1, wherein said step of generating a reminder comprises generating a text reminder, and wherein said step of defining an action comprises defining said action as displaying said text reminder.

12. The method of claim 2, wherein said step of generating a reminder comprises generating an audio reminder, and wherein said step of defining an action comprises defining said action as playing said audio reminder.

13. The method of claim 1, wherein said reminder, said indication of said triggering event and said indication of said action are stored in the communication device.

14. An apparatus for generating a reminder in a communication device or operating in a system, said apparatus comprising:
an input device for receiving input in the communication device, said input generating a reminder, defining a triggering event to be initiated external to the communication device, and defining an action, wherein said action is to be performed using said reminder upon occurrence of said triggering event;
at least one memory, said memory for storing said reminder, an indication of said triggering event, and an indication of said action in the system; and
a processor in the communication device, coupled to said input device and operable to communicate with said at least one memory, said processor for detecting occurrence of said triggering event and initiating performance of said action on said reminder in the communication device.

15. The apparatus for claim 14, wherein said reminder comprises a text reminder.

16. The apparatus of claim 15, wherein said input device receives keypad input to generate said text reminder.

17. The apparatus of claim 14, wherein said reminder comprises an audio reminder.

18. The apparatus of claim 15, wherein said input device records audio input to generate said audio reminder.

19. The apparatus of claim 14, wherein said reminder comprises a video reminder.

20. The apparatus of claim 19 wherein said input device records video input to generate said video reminder.

21. The apparatus of claim 14, wherein said triggering event comprises an incoming phone call from a selected phone number to the communication device.

22. The apparatus of claim 14, wherein said triggering event comprises an outgoing phone call to a selected phone number from the communication device.

23. The apparatus of claim 14, wherein said triggering event comprises an external event determinable by a sensor in the communication device.

24. The apparatus of claim 14, wherein said reminder comprises a text reminder and said action comprises displaying said text reminder.

25. The apparatus of claim 14, wherein said reminder comprises an audio reminder and said action comprises playing said audio reminder.

26. The apparatus of claim 14, wherein said memory is implemented in the mobile communication device.
